(19) United States
(12) Patent Application Publication
(10) Pub. No.: US 2015/0097929 A1
(43) Pub. Date: Apr. 9, 2015

(54) DISPLAY FOR THREE-DIMENSIONAL IMAGING

(71) Applicant: United Sciences, LLC., Atlanta, GA (US)

(72) Inventors: Harris Bergman, Marietta, GA (US); Giorgos Hatzilias, Buford, GA (US); Karol Hatzilias, Atlanta, GA (US); Ruizhi Hong, Roswell, GA (US); Wess Eric Sharpe, Atlanta, GA (US); Amy Stone, Milton, GA (US)

(21) Appl. No.: 14/049,666

(22) Filed: Oct. 9, 2013

(51) Int. Cl. H04N 13/02; H04L 29/06

(52) U.S. Cl. CPC H04N 13/0203; H04L 65/4069
USPC 348/47

(57) ABSTRACT

Disclosed are various embodiments for rendering multiple video streams in a display. A mobile computing device configured to perform a scan of an object utilizing the at least one imaging device may generate a first video stream utilizing the at least one imaging device. The mobile computing device may access a second video stream comprising at least a three-dimensional reconstruction of the object subject to the scan and may render the first video stream and the second video stream in a display in data communication with the mobile computing device.

### CROSS REFERENCE TO RELATED APPLICATIONS

This application is related to U.S. patent application Ser. No. ______, filed on Oct. ______, 2013 (Attorney Docket No. 52105-1010) and entitled “Tubular Light Guide,” U.S. patent application Ser. No. ______, filed on Oct. ______, 2013 (Attorney Docket No. 52105-1020) and entitled “Tapered Optical Guide,” U.S. patent application Ser. No. ______, filed on Oct. ______, 2013 (Attorney Docket No. 52105-1040) and entitled “Fan Light Element,” U.S. patent application Ser. No. ______, filed on Oct. ______, 2013 (Attorney Docket No. 52105-1050) and entitled “Integrated Tracking with World Modeling,” U.S. patent application Ser. No. ______, filed on Oct. ______, 2013 (Attorney Docket No. 52105-1060) and entitled “Integrated Tracking with Fiducial-based Modeling,” U.S. patent application Ser. No. ______, filed on Oct. ______, 2013 (Attorney Docket No. 52105-1070) and entitled “Integrated Calibration Cradle,” and U.S. patent application Ser. No. ______, filed on Oct. ______, 2013 (Attorney Docket No. 52105-1080) and entitled “Calibration of 3D Scanning Device,” all of which are hereby incorporated by reference in their entirety.

### BACKGROUND

There are various needs for understanding the shape and size of cavity surfaces, such as body cavities. For example, hearing aids, hearing protection, custom headphones, and wearable computing devices may require impressions of a patient's ear canal. To construct an impression of an ear canal, audiologists may inject a silicone material into a patient's ear canal, wait for the material to harden, and then provide the mold to manufacturers who use the resulting silicone impression to create a custom fitting in-ear device. As may be appreciated, the process is slow, expensive, and unpleasant for the patient as well as a medical professional performing the procedure.

Computer vision and photogrammetry generally relates to acquiring and analyzing images in order to produce data by electronically understanding an image using various algorithmic methods. For example, computer vision may be employed in event detection, object recognition, motion estimation, and various other tasks.

Three-dimensional reconstruction is the process of obtaining data relating to a shape and appearance of an object to generate a three-dimensional reconstruction of the object.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIGS. 1A-1C are drawings of an otoscanner according to various embodiments of the present disclosure.

FIG. 2 is a drawing of the otoscanner of FIGS. 1A-1C performing a scan of a surface according to various embodiments of the present disclosure.

FIGS. 3A-D are pictorial diagrams of example user interfaces rendered by a display in data communication with the otoscanner of FIGS. 1A-1C according to various embodiments of the present disclosure.

FIG. 4 is a drawing of the otoscanner of FIGS. 1A-1C further comprising a display according to various embodiments of the present disclosure.

FIG. 5 is a drawing of the otoscanner of FIGS. 1A-1C in data communication with an external display according to various embodiments of the present disclosure.

FIG. 6 is a drawing of the otoscanner of FIGS. 1A-1C in data communication with an external display according to various embodiments of the present disclosure.

FIG. 7 is a drawing of the otoscanner of FIGS. 1A-1C in data communication with an external display according to various embodiments of the present disclosure.

FIG. 8 is a drawing of the otoscanner of FIGS. 1A-1C in data communication with an external display according to various embodiments of the present disclosure.

FIG. 9 is a flowchart illustrating one example of functionality implemented as portions of a display application executed in a computing device according to various embodiments of the present disclosure.

FIG. 10 is a schematic block diagram that provides one example illustration of a computing device executing a display application according to various embodiments of the present disclosure.

### DETAILED DESCRIPTION

The present disclosure relates to a mobile scanning device configured to generate various displays for conducting a scan of a surface. Advancements in computer vision permit imaging or capture devices, such as conventional cameras, to be employed as sensors useful in determining locations, shapes, and appearances of objects in a three-dimensional space. For example, a position and an orientation of an object in a three-dimensional space may be determined relative to a certain world coordinate system utilizing digital images captured via image capturing devices. As may be appreciated, the position and orientation of the object in the three-dimensional space may be beneficial in generating additional data about the object, or about other objects, in the same three-dimensional space.

For example, scanning devices may be used in various industries to scan objects to generate data pertaining to the objects being scanned. A scanning device may employ an imaging device, such as a camera, to determine information about the object being scanned, such as the size, shape, appearance, or structure of the object, the distance of the object from the scanning device, etc.

As a non-limiting example, a scanning device may include an otoscanner configured to visually inspect or scan the ear canal of a human or animal. An otoscanner may comprise one or more cameras that may be beneficial in generating data about the ear canal subject of the scan, such as the size, shape, or structure of the ear canal. This data may be used in generating three-dimensional reconstructions of the ear canal that may be useful in customizing in-ear devices, such as hearing aids or wearable computing devices.

Determining the placement of a display to facilitate a scan of an object remains problematic. Thus, according to various embodiments of the present disclosure, a mobile computing device, such as an otoscanner, may be configured to perform a scan of an object utilizing at least one imaging device that may generate a first video stream. The mobile computing device may generate or otherwise access a second video stream comprising at least a three-dimensional reconstruction of the object subject to the scan and may render the first video stream and the second video stream in one or more displays in data communication with the mobile computing device, as will be described in greater detail below.

In the following discussion, a general description of the system and its components is provided, followed by a discussion of the operation of the same.

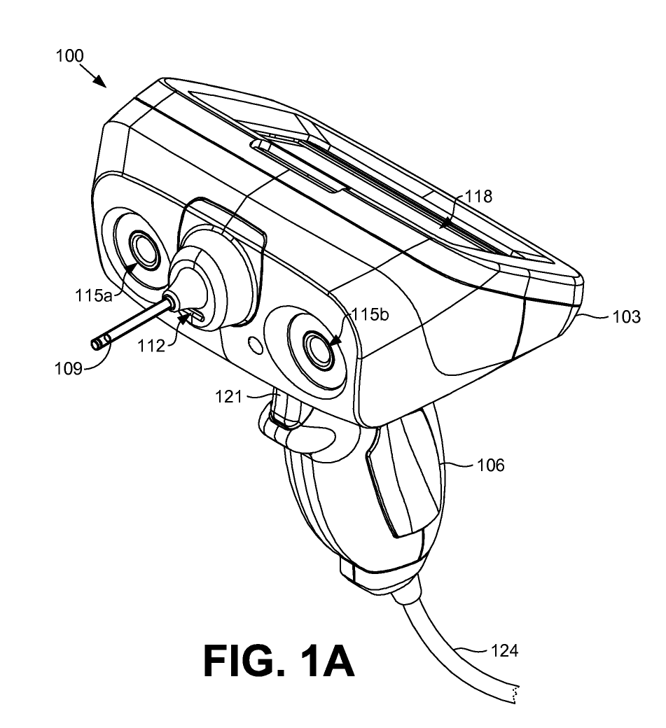

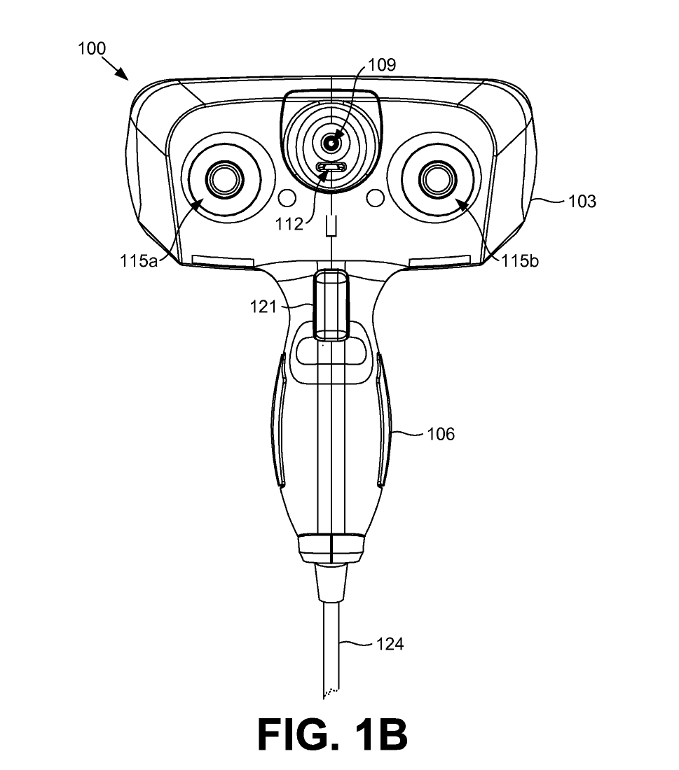

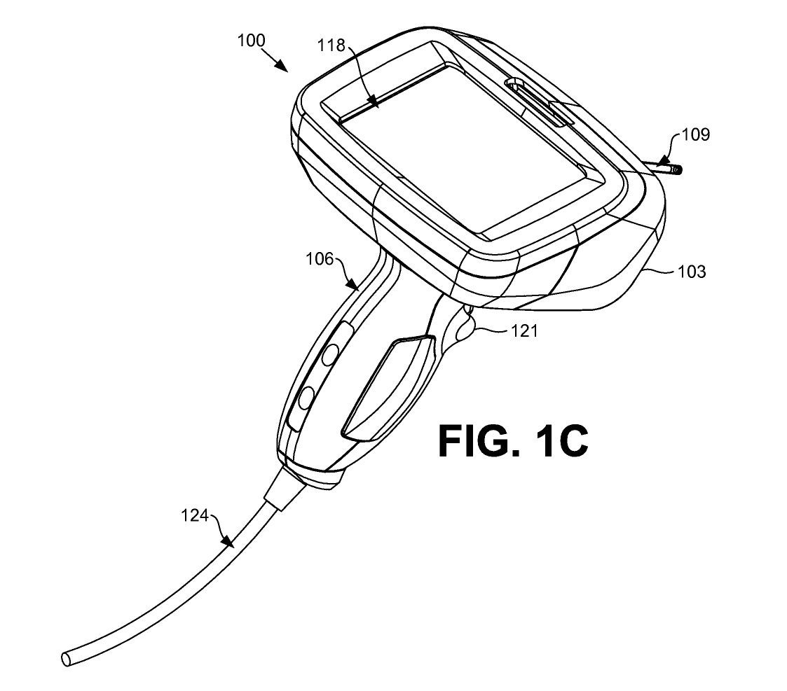

With reference to FIG. 1A, shown is an example drawing of a scanning device 100 according to various embodiments of the present disclosure. The scanning device 100, as illustrated in FIG. 1A, may comprise, for example, a body 103 and a hand grip 106. Mounted upon the body 103 of the scanning device 100 are a probe 109, a fan light element 112, and a plurality of tracking sensors comprising, for example, a first imaging device 115a and a second imaging device 115b. According to various embodiments, the scanning device 100 may further comprise a display screen 118 configured to render images captured via the probe 109, the first imaging device 115a, the second imaging device 115b, and/or other imaging devices.

The hand grip 106 may be configured such that the length is long enough to accommodate large hands and the diameter is small enough to provide enough comfort for smaller hands. A trigger 121, located within the hand grip 106, may perform various functions such as initiating a scan of a surface, controlling a user interface rendered in the display, and/or otherwise modifying the function of the scanning device 100.

The scanning device 100 may further comprise a cord 124 that may be employed to communicate data signals to external computing devices and/or to power the scanning device 100. As may be appreciated, the cord 124 may be detachably attached to facilitate the mobility of the scanning device 100 when held in a hand via the hand grip 106. According to various embodiments of the present disclosure, the scanning device 100 may not comprise a cord 124, thus acting as a wireless and mobile device capable of wireless communication.

The probe 109 mounted onto the scanning device 100 may be configured to guide light received at a proximal end of the probe 109 to a distal end of the probe 109 and may be employed in the scanning of a surface cavity, such as an ear canal, by placing the probe 109 near or within the surface cavity. During a scan, the probe 109 may be configured to project a 360-degree ring onto the cavity surface and capture reflections from the projected ring to reconstruct the image, size, and shape of the cavity surface. In addition, the scanning device 100 may be configured to capture video images of the cavity surface by projecting video illuminating light onto the cavity surface and capturing video images of the cavity surface.

The fan light element 112 mounted onto the scanning device 100 may be configured to emit light in a fan line for scanning an outer surface. The fan light element 112 comprises a fan light source projecting light onto a single element lens to collimate the light and generate a fan line for scanning the outer surface. By using triangulation of the reflections captured when projected onto a surface, the imaging sensor within the scanning device 100 may reconstruct the scanned surface.

FIG. 1A illustrates an example of a first imaging device 115a and a second imaging device 115b mounted on or within the body 103 of the scanning device 100, for example, in an orientation that is opposite from the display screen 118. The display screen 118, as will be discussed in further detail below, may be configured to render digital media of a surface cavity captured by the scanning device 100 as the probe 109 is moved within the cavity. The display screen 118 may also display, either separately or simultaneously, real-time constructions of three-dimensional images corresponding to the scanned cavity, as will be discussed in greater detail below.

Referring next to FIG. 1B, shown is another example drawing of the scanning device 100 according to various embodiments. In this example, the scanning device 100 comprises a body 103, a probe 109, a hand grip 106, a fan light element 112, a trigger 121, and a cord 124 (optional), all implemented in a fashion similar to that of the scanning device described above with reference to FIG. 1A. In the examples of FIGS. 1A and 1B, the scanning device 100 is implemented with the first imaging device 115a and the second imaging device 115b mounted within the body 103 without hindering or impeding a view of the first imaging device 115a and/or a second imaging device 115b. According to various embodiments of the present disclosure, the placement of the imaging devices 115 may vary as needed to facilitate accurate pose estimation, as will be discussed in greater detail below.

Turning now to FIG. 1C, shown is another example drawing of the scanning device 100 according to various embodiments. In the non-limiting example of FIG. 1C, the scanning device 100 comprises a body 103, a probe 109, a hand grip 106, a trigger 121, and a cord 124 (optional), all implemented in a fashion similar to that of the scanning device described above with reference to FIGS. 1A-1B.

In the examples of FIGS. 1A, 1B, and 1C, the scanning device 100 is implemented with the probe 109 mounted on the body 103 between the hand grip 106 and the display screen 118. The display screen 118 is mounted on the opposite side of the body 103 from the probe 109 and distally from the hand grip 106. To this end, when an operator takes the hand grip 106 in the operator's hand and positions the probe 109 to scan a surface, both the probe 109 and the display screen 118 are easily visible at all times to the operator.

Further, the display screen 118 is coupled for data communication to the imaging devices 115 (FIGS. 1A-1B). The display screen 118 may be configured to display and/or render images of the scanned surface. The displayed images may include digital images or video of the cavity captured by the probe 109 and the fan light element 112 (FIGS. 1A-1B) as the probe 109 is moved within the cavity. The displayed images may also include real-time constructions of three-dimensional images corresponding to the scanned cavity. The display screen 118 may be configured, either separately or simultaneously, to display the video images and the three-dimensional images, as will be discussed in greater detail below.

According to various embodiments of the present disclosure, the imaging devices 115 of FIGS. 1A, 1B, and 1C, may comprise a variety of cameras to capture one or more digital images of a surface cavity subject to a scan. A camera is described herein as a ray-based sensing device and may comprise, for example, a charge-coupled device (CCD) camera, a complementary metal-oxide semiconductor (CMOS) camera, or any other camera. Similarly, the camera employed as an imaging device 115 may comprise one of a variety of lenses such as apochromat (APO), process with pincushion distortion, process with barrel distortion, fisheye, stereoscopic, soft-focus, infared, ultraviolet, swivel, shift, wide angle, any combination thereof, and/or any other type of lens.

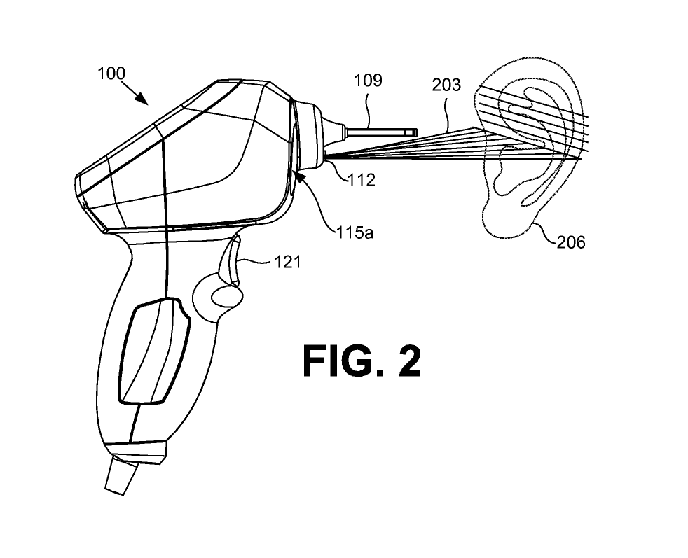

Moving on to FIG. 2, shown is an example of the scanning device 100 emitting a fan line 203 for scanning a surface. In this example, the scanning device 100 is scanning the surface of an ear 206. However, it should be noted that the scanning device 100 may be configured to scan other types of surfaces and is not limited to human or animal applications. The fan light element 112 may be designed to emit a fan line 203 formed by projecting divergent light generated by the fan light source onto the fan lens. As the fan line 203 is projected onto a surface, the lens system may capture reflections of the fan line 203. An image sensor may use triangulation to construct an image of the scanned surface based at least in part on the reflections captured by the lens system. Accordingly, the constructed image may be displayed on the display screen 118 (FIGS. 1A and 1C) and/or other displays in data communication with the scanning device 100.

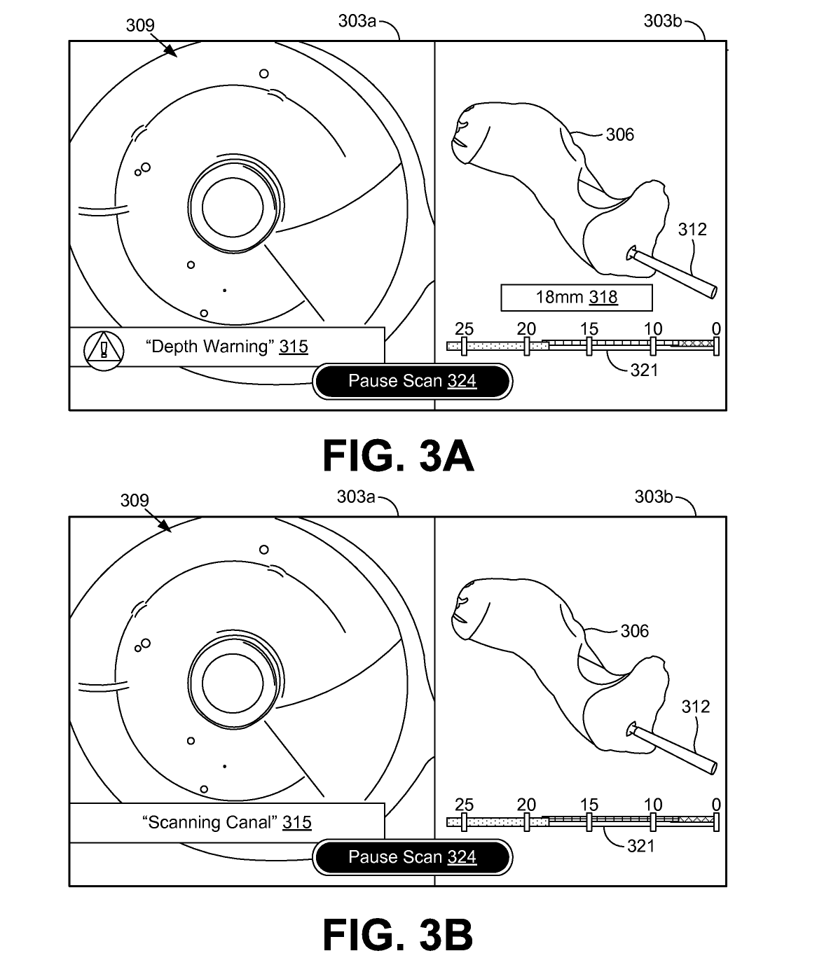

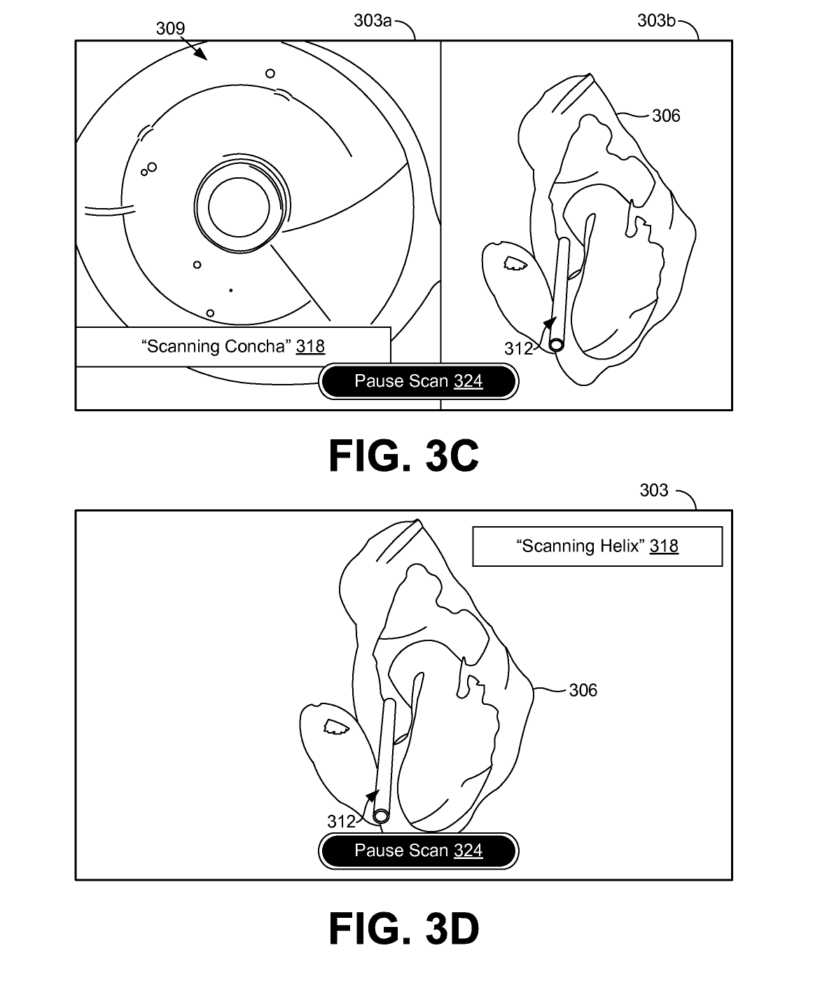

Referring next to FIGS. 3A-D, shown are example user interfaces that may be rendered, for example, in a display screen 118 (FIG. 1A) within the scanning device 100 (FIG. 1A) or in any other display in data communication with the scanning device 100. In the non-limiting example of FIGS. 3A-D, a user interface may comprise a first video stream 303a and a second video stream 303b rendered separately or simultaneously in a display. For example, in the first video stream 303a of FIGS. 3A-C, a real-time video stream may be rendered, providing an operator of the scanning device 100 with a view of a surface cavity being scanned. The real-time video stream may be generated via the probe 109 or via one of the imaging devices 115.

In the second video stream 303b of FIGS. 3A-C, a real-time three-dimensional reconstruction 306 of the object being scanned may be rendered, providing the operator of the scanning device 100 with an estimate regarding what portion of the surface cavity has been scanned. For example, the three-dimensional reconstruction 306 may be non-existent as a scan of a surface cavity is initiated by the operator. As the operator progresses in conducting a scan of the surface cavity, a three-dimensional reconstruction 306 of the surface cavity may be generated portion-by-portion, progressing into a complete reconstruction of the surface cavity at the completion of the scan. In the non-limiting examples of FIGS. 3A-C, the first video stream 303a may comprise, for example, an inner view of an ear canal 309 generated by the probe 109 and the second video stream 303b may comprise, for example, a three-dimensional reconstruction 306 of at least a portion of an ear canal, or vice versa.

A three-dimensional reconstruction 306 of an ear canal may be generated via one or more processors internal to the scanning device 100, external to the scanning device 100, or a combination thereof. Generating the three-dimensional reconstruction 306 of the object subject to the scan may require information related to the pose of the scanning device 100. The three-dimensional reconstruction 306 of the ear canal may further comprise, for example, a probe model 312 emulating a position of the probe 109 relative to the surface cavity being scanned by the scanning device.

A notification area 315 may provide the operator of the scanning device 100 with notifications, whether assisting the operator with conducting a scan or warning the operator of potential harm to the object being scanned. Measurements 318 may be rendered in the display to assist the operator in conducting scans of surface cavities at certain distances and/or depths. A bar 321 may provide the operator with an indication of which depths have been thoroughly scanned as opposed to which depths or distances remain to be scanned. One or more buttons 324 may be rendered in various locations of the user interface permitting the operator to initiate a scan of an object and/or manipulate the user interface presented on the display screen 118 or other display in data communication with the scanning device 100.

According to one embodiment, the user interfaces of FIGS. 3A-D are rendered in a touch-screen display permitting the operator to engage a button 324 to pause and/or resume an ongoing scan using a hand or similar means. Thus, the button 324 may provide a solution to engage the program to manipulate a rendering of the one or more video streams. For example, a button 324, or similar component, may facilitate a view of the three-dimensional reconstruction depicted in the video stream 303b.

Although a first video stream 303a and a second video stream 303b are shown simultaneously in a side-by-side arrangement, other embodiments may be employed without deviating from the scope of the user interface. For example, the first video stream 303a may be rendered in the display screen 118 on the scanning device 100 and the second video stream 303b may be rendered in a display external to the scanning device 100, and vice versa, as will be discussed in greater detail below.

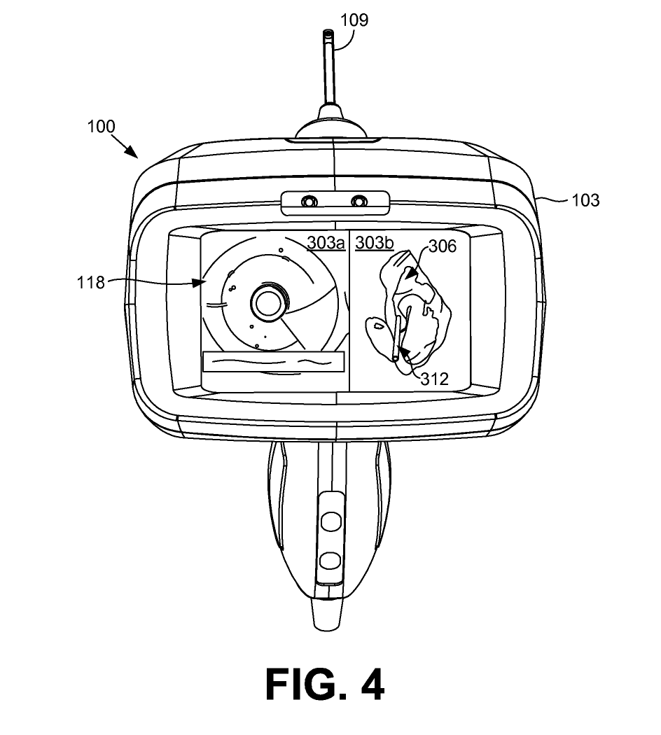

Referring next to FIG. 4, shown is the scanning device 100 of FIGS. 1A-1C according to various embodiments of the present disclosure. In the non-limiting example of FIG. 4, the first video stream 303a and the second video stream 303b of FIG. 3C are rendered in a display 118 housed within the body 103 of the scanning device 100. The first video stream 303a may be generated by the probe 109 or via one of the imaging devices 115 (FIGS. 1A-1B) providing an operator of the scanning device 100 with a view of a surface cavity being scanned.

As shown in FIG. 4, the second video stream 303b may be rendered with the first video stream 303a simultaneously in a side-by-side arrangement. The second video stream 303b may comprise, for example, a three-dimensional reconstruction 306 of an ear canal subject to a scan via the scanning device 100. The three-dimensional reconstruction 306 of the ear canal may further comprise, for example, a probe model 312 emulating a position of the probe 109 relative to the surface cavity being scanning by the scanning device. In the non-limiting example of FIG. 4, the three-dimensional reconstruction 306 may be generated in a processor internal to the scanning device 100. Although the first video stream 303a is shown to the left of the second video stream 303b, the arrangement is not so limited, and the rendered position of the video streams 303 in the display 118 may vary.

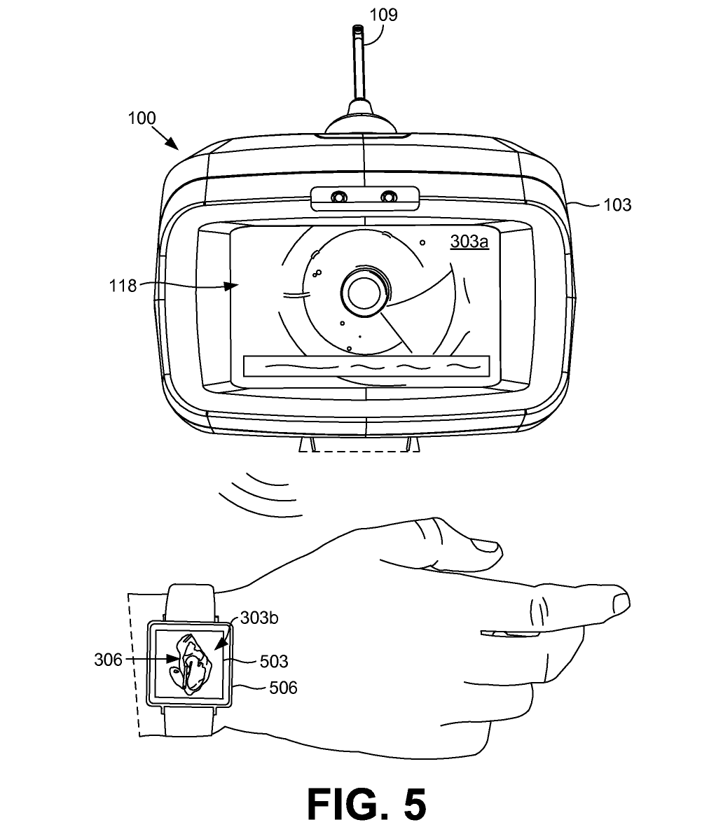

Turning now to FIG. 5, shown is the scanning device 100 of FIGS. 1A-1C according to various embodiments of the present disclosure. In the non-limiting example of FIG. 5, the first video stream 303a is rendered in a display 118 housed within the body 103 of the scanning device 100 while the second video stream 303b is rendered in an external display 503 independent from the scanning device 100. The first video stream 303a may be generated by the probe 109 or via one of the imaging devices 115 (FIGS. 1A-1B) providing an operator of the scanning device 100 with a view of a surface cavity being scanned. As the operator handles the scanning device 100 with, for example, the operator's hand, the operator may perceive a position of the scanning device 100 relative to the surface being scanned via the first video stream 303a.

As depicted in FIG. 5, the second video stream 303b may be rendered in an external display located outside the scanning device 100. In the non-limiting example of FIG. 5, a three-dimensional reconstruction 306 of an ear canal subject to a scan via the scanning device 100 may be rendered in an external display 503 worn about a human wrist similar to a wrist device 506. According to various embodiments, the three-dimensional reconstruction 306 may be generated in a processor internal to the scanning device 100 and communicated to the wrist device 506 via a form of wired or wireless communication, such as, for example, wireless telephony, Wi-Fi, Bluetooth™, Zigbee, infrared (IR), Universal Serial Bus (USB), High-Definition Multimedia Interface (HMDI), Ethernet, or any other form of data communication. In another embodiment, the three-dimensional reconstruction 306 may be generated in a processor internal to the wrist device 506 based at least in part on data transmitted from the scanning device 100 that may be used in generating the three-dimensional reconstruction 306 and/or rendering a first video stream 303a or the second video stream 303b.

Although FIG. 5 depicts the first video stream 303a rendered in the scanning device 100 and the second video stream 303b rendered in the wrist device 506, the embodiment is not limited to this arrangement. For example, the first video stream 303a generated via the probe 109 or an imaging device 115 may be rendered on the external display 503 within the wrist device 506 and the second video stream 303b may be rendered in the display 118 internally housed within the body 103 of the scanning device 100.

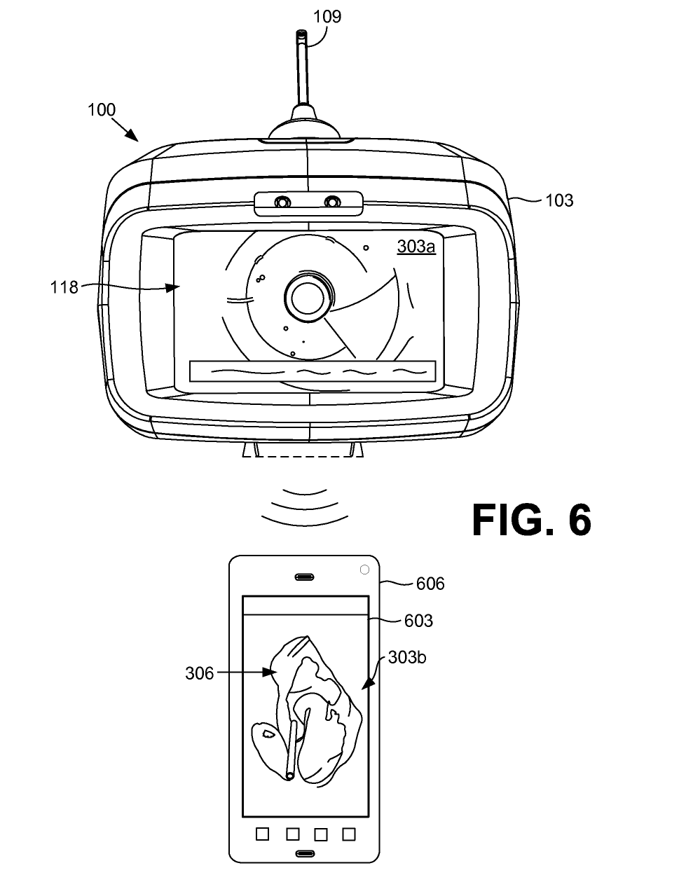

Moving on to FIG. 6, shown is the scanning device 100 of FIGS. 1A-1C according to various embodiments of the present disclosure. In the non-limiting example of FIG. 6, the first video stream 303a is rendered in a display 118 housed within the body 103 of the scanning device 100 while the second video stream 303b is rendered in an external display 603 independent from the scanning device 100. As discussed above, the first video stream 303a may be generated by the probe 109 or via one of the imaging devices 115 (FIGS. 1A-1B) providing an operator of the scanning device 100 with a view of a surface cavity being scanned. As the operator handles the scanning device 100 with, for example, the operator's hand, the operator may perceive a position of the scanning device 100 relative to the surface being scanned via the first video stream 303a.

As shown in FIG. 6, the second video stream 303b may be rendered in an external display 603 located outside the scanning device 100. In the non-limiting example of FIG. 6, a three-dimensional reconstruction 306 of an ear canal subject to a scan via the scanning device 100 may be rendered in an external display 603 of a mobile computing device 606. A mobile computing device 606 may comprise, for example, a smartphone, a tablet, a laptop, or any similar device. An application executing on the mobile computing device 606 may render the first video stream 303a or the second video stream 303b in the external display 603 utilizing, for example, data communicated to the mobile computing device 606 from the scanning device 100.

According to various embodiments, the three-dimensional reconstruction 306 may be generated in a processor internal to the scanning device 100 and communicated to the mobile computing device 606 via a form of wired or wireless communication consisting of, for example, wireless telephony, Wi-Fi, Bluetooth™, Zigbee, IR, USB, HMDI, Ethernet, or any other form of data communication. In another embodiment, the three-dimensional reconstruction 306 may be generated in a processor internal to the mobile computing device 606 based at least in part on data transmitted from the scanning device 100 that may be used in generating the three-dimensional reconstruction 306 and/or rendering a first video stream 303a or the second video stream 303b.

Although FIG. 6 depicts the first video stream 303a rendered in the display housed within the body 103 of the scanning device 100 and the second video stream 303b rendered in the mobile computing device 606, the embodiment is not limited to this arrangement. For example, the first video stream 303a generated via the probe 109 or an imaging device 115 may be rendered on the external display 603 within the mobile computing device 606 and the second video stream 303b may be rendered in the display 118 internally housed within the body 103 of the scanning device 100.

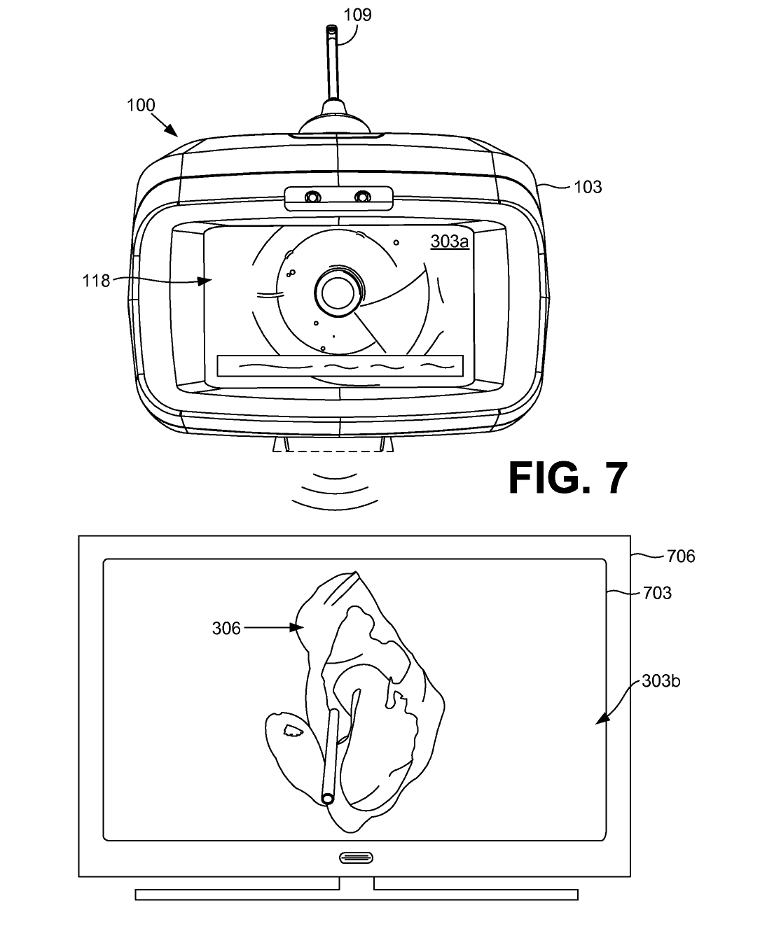

Referring next to FIG. 7, shown is the scanning device 100 of FIGS. 1A-1C according to various embodiments of the present disclosure. In the non-limiting example of FIG. 7, the first video stream 303a is rendered in a display 118 housed within the body 103 of the scanning device 100 while the second video stream 303b is rendered in an external display 603 independent from the scanning device 100. As discussed above, the first video stream 303a may be generated by the probe 109 or via one of the imaging devices 115 (FIGS. 1A-1B) providing an operator of the scanning device 100 with a view of a surface cavity being scanned. As the operator handles the scanning device 100 with, for example, the operator's hand, the operator may perceive a position of the scanning device 100 relative to the surface being scanned via the first video stream 303a.

As depicted in FIG. 7, the second video stream 303b may be rendered in an external display 703 located outside the scanning device 100. In the non-limiting example of FIG. 7, a three-dimensional reconstruction 306 of an ear canal subject to a scan via the scanning device 100 may be rendered in an external display 703 of a monitor 706. A monitor 706 may comprise, for example, a television monitor, a computer monitor, or any similar device. An application executing on the monitor 706 may render the first video stream 303a or the second video stream 303b in the external display 703 utilizing, for example, data communicated to the monitor 706 from the scanning device 100.

According to various embodiments, the three-dimensional reconstruction 306 may be generated in a processor internal to the scanning device 100 and communicated to the monitor 706 via a form of wired or wireless communication consisting of, for example, wireless telephony, Wi-Fi, Bluetooth™, Zigbee, IR, USB, HMDI, analog video, Ethernet, or any other form of data communication. In another embodiment, the three-dimensional reconstruction 306 may be generated in a processor internal to the monitor 706 based at least in part on data transmitted from the scanning device 100 that may be used in generating the three-dimensional reconstruction 306 and/or rendering a first video stream 303a or the second video stream 303b.

Although FIG. 7 depicts the first video stream 303a rendered in the display housed within the body 103 of the scanning device 100 and the second video stream 303b rendered in the external display 703 of the monitor 706, the embodiment is not limited to this arrangement. For example, the first video stream 303a generated via the probe 109 or an imaging device 115 may be rendered on the external display 703 within the monitor 706 and the second video stream 303b may be rendered in the display 118 internally housed within the body 103 of the scanning device 100.

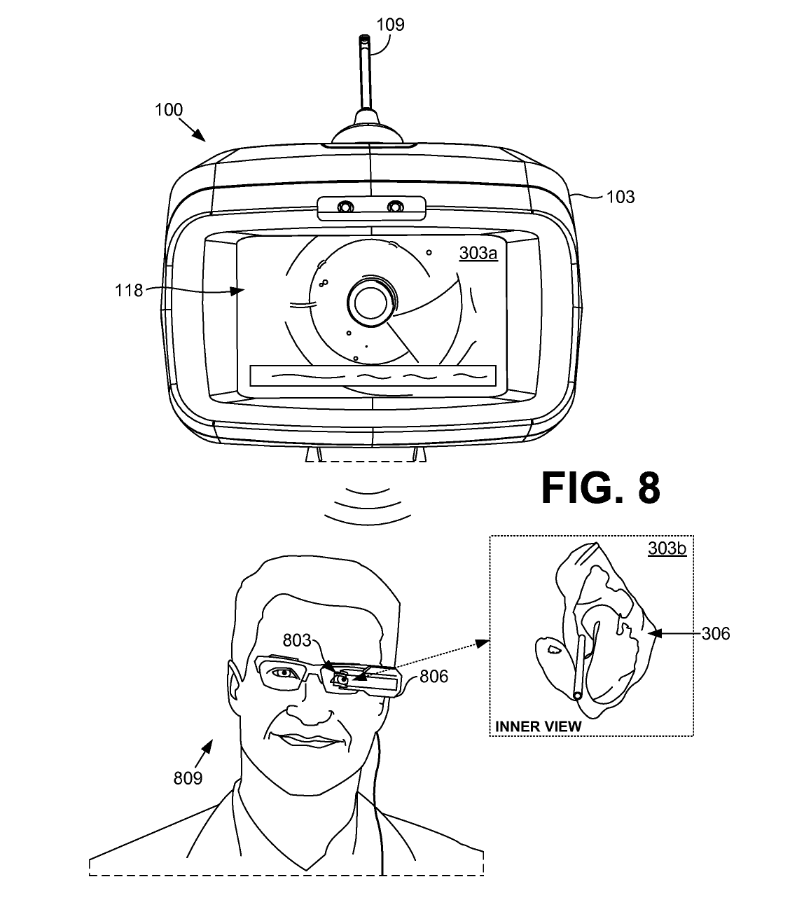

Turning now to FIG. 8, shown is the scanning device 100 of FIGS. 1A-1C according to various embodiments of the present disclosure. In the non-limiting example of FIG. 8, the first video stream 303a is rendered in a display 118 housed within the body 103 of the scanning device 100 while the second video stream 303b is rendered in an external display 803 independent from the scanning device 100. As discussed above, the first video stream 303a may be generated by the probe 109 or via one of the imaging devices 115 (FIGS. 1A-1B) providing an operator of the scanning device 100 with a view of a surface cavity being scanned. As the operator handles the scanning device 100 with, for example, the operator's hand, the operator may perceive a position of the scanning device 100 relative to the surface being scanned via the first video stream 303a.

As depicted in FIG. 8, the second video stream 303b may be rendered in an external display 803 located outside the scanning device 100. In the non-limiting example of FIG. 8, a three-dimensional reconstruction 306 of an ear canal subject to a scan via the scanning device 100 may be rendered in an external display 803 of a head-mounted display device 806. A head-mounted display device 806 may comprise, for example, a device wearable about a head of a human 809 such that a display is located within sight of the human 809 wearing the device. An application executing on the head-mounted display device 806 may render the first video stream 303a or the second video stream 303b in the external display 803 utilizing, for example, data communicated to the head-mounted display device 806 from the scanning device 100.

According to various embodiments, the three-dimensional reconstruction 306 may be generated in a processor internal to the scanning device 100 and communicated to the head-mounted display device 806 via a form of wired or wireless communication consisting of, for example, wireless telephony, Wi-Fi, Bluetooth™, Zigbee, IR, USB, HMDI, analog video, Ethernet, or any other form of data communication. In another embodiment, the three-dimensional reconstruction 306 may be generated in a processor internal to the head-mounted display device 806 based at least in part on data transmitted from the scanning device 100 that may be used in generating the three-dimensional reconstruction 306 and/or rendering a first video stream 303a or the second video stream 303b.

Although FIG. 8 depicts the first video stream 303a rendered in the display housed within the body 103 of the scanning device 100 and the second video stream 303b rendered in the external display 803 of the head-mounted display device 806, the embodiment is not limited to this arrangement. For example, the first video stream 303a generated via the probe 109 or an imaging device 115 may be rendered on the external display 803 within the head-mounted display device 806 and the second video stream 303b may be rendered in the display 118 internally housed within the body 103 of the scanning device 100.

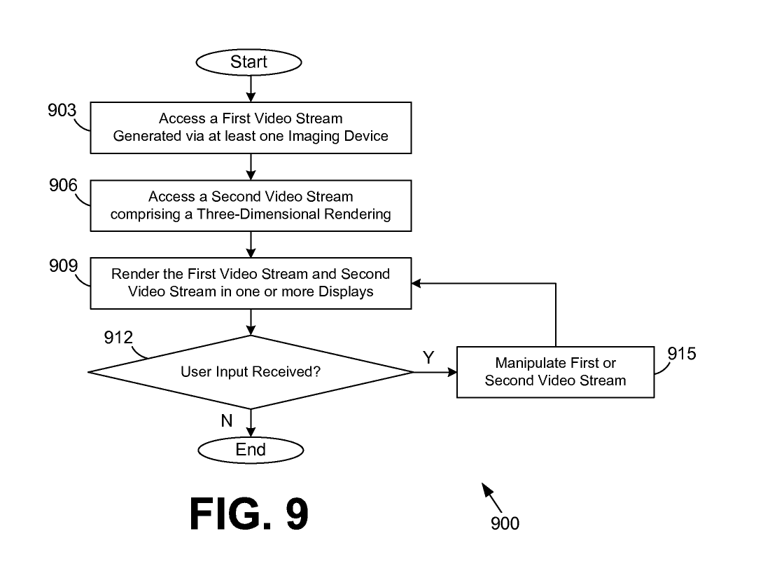

Moving on to FIG. 9, shown is a flowchart that provides one example of the operation of a portion of a display application 900 according to various embodiments. It is understood that the flowchart of FIG. 9 provides merely an example of the many different types of functional arrangements that may be employed to implement the operation of the portion of the display application 900 as described herein. As an alternative, the flowchart of FIG. 9 may be viewed as depicting an example of steps of a method implemented in a computing device (e.g., scanning device 100 (FIGS. 1A-1C)) according to one or more embodiments.

Beginning with 903, a first video stream generated via at least one imaging device 115 (FIGS. 1A-B) is accessed. As discussed above, an imaging device 115 or a probe 109 (FIGS. 1A-1C) in data communication with the scanning device 100 may generate a video stream 303 (FIGS. 3A-3D). The video stream 303 may be accessed directly from the imaging device 115, from the scanning device 100, or accessed from memory. As a non-limiting example, a first video stream 303a may comprise video generated during a scanning of an object that provides an operator of the scanning device 100 with a video feed that may assist in the scan of the object.

Next, in 906, a second video stream 303b comprising a three-dimensional reconstruction 306 (FIGS. 3A-3D) of the object subject to the scan may be accessed. For example, the second video stream 303b may be accessed directly from a processor generating the three-dimensional reconstruction 306 or from memory. According to various embodiments, the three-dimensional reconstruction 306 may be generated in real-time, providing the operator of the scanning device 100 with portions of the surface cavity that have been scanned and reconstructed.

In 909, the first video stream 303a and the second video stream 303b may be rendered in one or more display devices. According to various embodiments, both the first video stream 303a and the second video stream 303b may be rendered in the same display 118 of a scanning device 100, as depicted in FIG. 4. Alternatively, the first video stream 303a and/or the second video stream 303b may be generated in one or more displays external to the scanning device, as depicted in FIGS. 5-8.

In 912, a device used to render the first video stream 303a and/or the second video stream 303b may be monitored for user input to determine whether user input has been received. In the embodiment of a display device comprising a touch-screen display, the touch-screen display may be monitored to determine whether a touch of the surface of the display has been conducted by an operator of the scanning device 100. Similarly, in the embodiment of a display in data communication with one or more other input devices (e.g., mouse, keyboard, voice recognition device, gesture recognition device, or any other input device), the input devices may be monitored to determine whether an interaction with one or both of the video streams 303 has been conducted by an operator of the scanning device 100.

If a user input has been detected, in 915, then the first or second video stream 303 may be manipulated according to the user input identified in 912. For example, in the event a user may want to rotate a view of the three-dimensional reconstruction 306 of the object subject to the scan, a user may initiate a swipe across a touch-screen display in which the three-dimensional reconstruction 306 is rendered. The video stream rendering the three-dimensional reconstruction 306 may modify the generated view of the three-dimensional reconstruction 306 accordingly. Thus, the rendering of the second video stream 303b in the touch-screen display will be modified according to the user input in box 909.

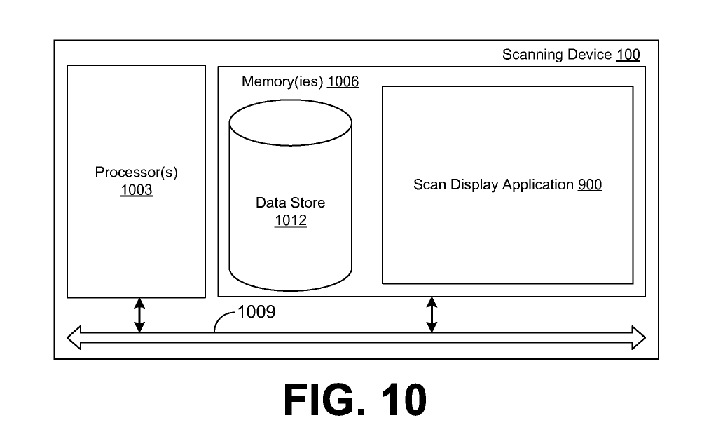

With reference to FIG. 10, shown is a schematic block diagram of a computing arrangement according to an embodiment of the present disclosure. For example, the scanning device 100 may comprise at least one processor circuit, for example, having a processor 1003 and a memory 1006, both of which are coupled to a local interface 1009. The local interface 1009 may comprise, for example, a data bus with an accompanying address/control bus or other bus structure as can be appreciated.

Stored in the memory 1006 are both data and several components that are executable by the processor 1003. In particular, a display application 900 is stored in the memory 1006 and executable by the processor 1003, as well as other applications. Also stored in the memory 1006 may be a data store 1012 and other data. In addition, an operating system may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Similarly, the computing arrangement described above with respect to FIG. 10 may be employed in the computing devices described throughout. For example, the computing arrangement of FIG. 10 may be embodied in the wrist device 506 of FIG. 5, the mobile computing device 606 of FIG. 6, the monitor 706 of FIG. 7, and the head-mounted display device 806 of FIG. 8.

Although the display application 900, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 9 shows the functionality and operation of an implementation of portions of the display application 900. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1003 in a computer system or other system. The machine code may be converted from the source code, etc. If embodied in hardware, each block may represent a circuit or a number of interconnected circuits to implement the specified logical function(s).

Although the flowchart of FIG. 9 shows a specific order of execution, it is understood that the order of execution may differ from that which is depicted. For example, the order of execution of two or more blocks may be scrambled relative to the order shown. Also, two or more blocks shown in succession in FIG. 9 may be executed concurrently or with partial concurrence. Further, in some embodiments, one or more of the blocks shown in FIG. 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the display application 900, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the display application 900, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same scanning device 100, or in multiple computing devices in a common computing environment. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system, comprising:
a mobile computing device configured to perform a scan of a surface utilizing at least one imaging device in data communication with the mobile computing device; and
a display application executable in the mobile computing device, the display application comprising logic that:
accesses a first video stream generated via the at least one imaging device;
accesses a second video stream comprising at least a three-dimensional reconstruction of the surface subject to the scan; and
renders the first video stream and the second video stream in a display in data communication with the mobile computing device.

2. The system of claim 1, wherein the display is located on the mobile computing device.

3. The system of claim 1, wherein the second video stream comprising at least the three-dimensional reconstruction of the surface is rendered in real-time.

4. The system of claim 1, wherein the second video stream comprising at least the three-dimensional reconstruction of the surface subject to the scan is generated via at least one computing device at a location different from the mobile computing device.

5. The system of claim 1, wherein the display further comprises at least a first display and a second display, the first display and the second display in data communication with the mobile computing device.

6. The system of claim 5, wherein the display application further comprises logic that renders the first video stream in the first display and the second video stream in the second display.

7. The system of claim 1, wherein the at least one imaging device comprises a plurality of imaging devices.

8. The system of claim 1, wherein the display comprises a touch-screen display.

9. The system of claim 8, wherein the display application further comprises logic that manipulates the second video stream in response to an input from a user of the touch-screen display to manipulate the second video stream.

10. A method, comprising:
accessing, by a mobile computing device, a first video stream generated via at least one capture device in data communication with the mobile computing device, wherein the mobile computing device is configured to perform a scan of an object utilizing the at least one capture device;
accessing, by the mobile computing device, a second video stream comprising at least a three-dimensional reconstruction of the object subject to the scan; and
rendering, by the mobile computing device, the first video stream and the second video stream in a display in data communication with the mobile computing device.

11. The method of claim 10, wherein the display is located on the mobile computing device.

12. The method of claim 10, wherein the second video stream comprising at least the three-dimensional reconstruction of the object is rendered in real-time.

13. The method of claim 10, wherein the second video stream comprising at least the three-dimensional reconstruction of the object subject to the scan is generated via at least one computing device at a location different from the mobile computing device.

14. The method of claim 10, wherein the display comprises at least a first display and a second display, the first display and the second display in data communication with the mobile computing device.

15. The method of claim 14, further comprising rendering, by the mobile computing device, the first video stream in the first display and the second video stream in the second display.

16. The method of claim 10, wherein the at least one capture device comprises a plurality of capture devices.

17. The method of claim 10, wherein the display comprises a touch-screen display.

18. The method of claim 17, further comprising manipulating, by the mobile computing device, the second video stream in response to an input from a user of the touch-screen display to manipulate the second video stream.

19. A non-transitory computer-readable medium embodying a program executable in a mobile computing device comprising a plurality of capture devices, the program comprising code that:
accesses a first video stream generated by at least one of the plurality of capture devices during a scan of an object, wherein the mobile computing device is configured to perform the scan of the object utilizing the at least one of the plurality of capture devices;
accesses a second video stream comprising at least a three-dimensional reconstruction of the object subject to the scan and a model emulating a position of the at least one of the plurality of capture devices relative to the object subject to the scan;
renders the first video stream in a first display within the mobile computing device and the second video stream in a second display independent from the mobile computing device, the first display and the second display both in data communication with the mobile computing device; and
manipulates the second video stream in response to an input from a user of the second display to manipulate the second video stream.

20. The non-transitory computer-readable medium of claim 19, wherein the second video stream comprising at least the three-dimensional reconstruction of the object subject to the scan is generated via at least one computing device at a location different from the mobile computing device.
